(19) United States
(12) Patent Application Publication
(10) Pub. No.: US 2005/0134145 A1
(43) Pub. Date: Jun. 23, 2005

(54) Ultrasonic motor

(75) Inventors: Tomoyuki Miyazaki, Kakegawa-shi (JP); Shigeki Toyama, Tokyo (JP)

Correspondence Address: MILES & STOCKBRIDGE PC, 1751 PINNACLE DRIVE, SUITE 500, MCLEAN, VA, 22102-3833, US

(73) Assignees: NSK-Warner K.K.; Shigeki Toyama

(21) Appl. No.: 10/946,313

(22) Filed: Sep. 22, 2004

(30) Foreign Application Priority Data
Sep. 26, 2003 (JP) 2003-335994
Feb. 6, 2004 (JP) 2004-031098

(51) Int. Cl. H02N 2/00

(52) U.S. Cl. 310/323.11

(57) ABSTRACT

An ultrasonic motor which can increase a frictional force between a stator and a rotor by maintaining a coefficient of friction of a frictional member high to thereby increase a torque capacity and the speed of rotation without increase of a voltage to be supplied or a pressing load, is disclosed. The ultrasonic motor is provided with a frictional member interposed between a vibrator and a member to be vibrated. The frictional member has a porosity of 20 to 80%.

This application claims the benefit of Japanese Patent applications No. 2003-335994 and No. 2004-031098 which are hereby incorporated by reference.

### BACKGROUND OF THE INVENTION

1. Field of the Invention

The present invention relates to an ultrasonic motor which is used, for example, in a knee supporter, a joint supporting device, or the like.

2. Related Background Art

As disclosed in Japanese Patent Application Laid-Open Nos. 5-83960 and 2001-178158, an ultrasonic motor is provided with a stator having a piezoelectric element and a rotor which is opposed thereto and in tight contact therewith. Comb-teeth like grooves are formed on a surface of the stator opposed to the rotor. On the back of this stator, the piezoelectric element is attached.

With the above arrangement, when a high frequency voltage is applied to the piezoelectric element while the rotor is superposed on the side of the comb-teeth like grooves of the stator so that they are brought into tight contact with pressure, an electrostrictive phenomenon is caused to produce ultrasonic vibration. This produced ultrasonic vibration advances in one direction continuously while flexing the stator, so that a so-called elliptic motion is generated in the stator, whereby the rotor is rotated in a predetermined direction at a predetermined torque.

A frictional member is bonded onto a surface of the rotor facing the stator. The frictional member is mostly formed of synthetic resin in the conventional art. A frictional member formed of carbon-fiber reinforced plastic is disclosed in Japanese Patent Application Laid-Open No. 5-83960. Further, Japanese Patent Application Laid-Open No. 2001-178158 discloses a frictional member which is subjected to oil-repellant surface treatment such as a Teflon (registered trade mark) coating or the like in which the surface thereof is formed finely uneven and recesses on this uneven surface are not filled up.

Note that Japanese Patent Application Laid-Open No. 2000-328043 discloses a wet frictional member which is employed in a clutch or a brake used in oil in an automatic transmission for a car, or the like.

In such an ultrasonic motor, in order to increase a torque capacity thereof, it is required to increase the amplitude of a vibrator which is the stator or to increase a load for pressing a rotor serving as a member to be vibrated against the stator serving as the vibrator.

In order to accelerate the rotation speed of such a motor, it is required to reduce a pressing load or force or to increase the frequency of a voltage to be supplied to the ultrasonic motor.

However, when the amplitude of the vibrator (stator) is increased or when the pressing load described above is increased, a contact surface pressure of the frictional member becomes comparatively high. As a result, abrasion or wear of the frictional member may be quickened, and the power to be consumed may be increased.

In other words, even when a voltage to be supplied to the ultrasonic motor and the pressing load are set in the same manner as in the conventional scheme, it is possible to increase the torque capacity or the speed of rotation if the coefficient of friction of the frictional member is maintained as high so as to increase a frictional force between the stator and the rotor. If the pressing load is reduced so that the same torque capacity and the speed of rotation as those in the conventional scheme are set, it is possible to suppress quickened abrasion of the frictional member, thereby improving the abrasion fastness thereof. As a result, it is rendered possible to realize high durability and long life.

### SUMMARY OF THE INVENTION

The present invention has been contrived taking the circumstances as described above into consideration, and an object of the invention is to provide an ultrasonic motor which can increase a frictional force between a stator and a rotor by maintaining a coefficient of friction of a frictional member high to thereby increase a torque capacity and the speed of rotation without increase of a voltage to be supplied or a pressing load.

In order to achieve the above object, according to the present invention, there is provided an ultrasonic motor with a frictional member interposed between a vibrator and a member to be vibrated, wherein the frictional member has a porosity of 20 to 80%.

If the porosity is less than 20%, the coefficient of friction becomes low, and the torque capacity of the ultrasonic motor becomes small. On the other hand, when the porosity exceeds 80%, the frictional member absorbs vibration from the vibrator (stator) so that a desired torque can not be produced.

In the ultrasonic motor according to the present invention, the hardness of the frictional member is preferably 60 to 100 based on HRR.

The hardness of the frictional member is increased when a ratio of filler/friction adjusting agents contained in the frictional member is increased or a large amount of binder (resin) is permeated. Conversely, when ratios of these are decreased, the frictional member becomes softer. In order to achieve the object of the present invention, it is desired that the HRR hardness of the frictional member is 60 to 100.

In the ultrasonic motor according to the present invention, the frictional member is preferably a paper type wet frictional member.

In the ultrasonic motor according to the present invention, the frictional member is preferably fixedly secured to at least one of the vibrator and the member to be vibrated.

In the ultrasonic motor according to the present invention, the vibrator is preferably a stator while the member to be vibrated is preferably a rotor.

In the ultrasonic motor according to the present invention, it is preferable that the stator which is formed of a piezoelectric element and an elastic member fixedly secured thereto and the rotor with a wet frictional member fixedly secured thereto are disposed to overlap each other to be rotatable coaxially, and load imparting means for imparting a load for binding the stator and the rotor together is further provided.

As described above, according to the present invention, since the frictional member interposed between the vibrator and the member to be vibrated has porosity of 20 to 80%, it is rendered possible to maintain a coefficient of friction of a frictional member high and to increase a frictional force between the stator and the rotor to thereby increase a torque capacity and the speed of rotation even when a voltage to be supplied to the ultrasonic motor and a pressing load are set in the same manner as in the conventional manner.

### BRIEF DESCRIPTION OF THE DRAWINGS

FIG. 1 is a perspective view of an ultrasonic motor which is provided with a measuring device required for a test, according to an embodiment of the present invention; and

FIG. 2A is a front view showing a state in which a frictional member is secured to a rotor, and

FIG. 2B is a cross-sectional view of the rotor in the axial direction thereof.

### DESCRIPTION OF PREFERRED EMBODIMENTS

An ultrasonic motor according to an embodiment of the present invention will be described below with reference to drawings.

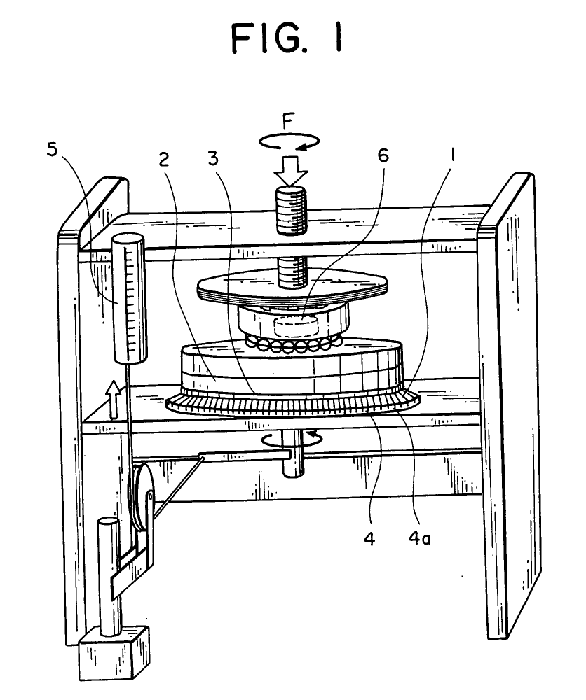

FIG. 1 is a perspective view of an ultrasonic motor which is provided with a measuring device required for a test, according to an embodiment of the present invention.

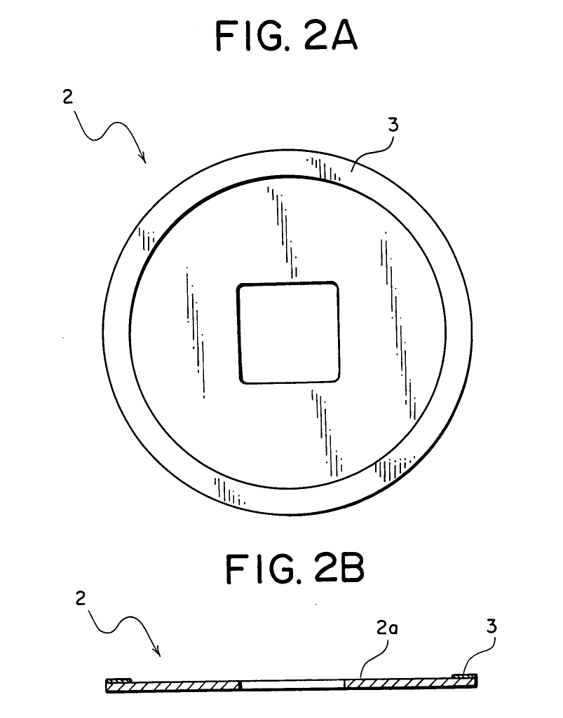

FIG. 2A is a front view showing a state in which a frictional member is secured to a rotor, and FIG. 2B is a cross-sectional view of the rotor in the axial direction thereof.

As shown in FIG. 1, the frictional member 3 is fixedly secured to the rotor 2 and the stator 1 is disposed coaxially to overlap. The rotor 2 and the stator 1 are provided to be mutually rotatable.

The stator 1 is composed of a piezoelectric device (not shown) and an elastic member 4, and the elastic member 4 is annularly provided with a plurality of slits 4a. This elastic member 4 is formed of metal such as iron or copper.

On the other hand, the rotor 2 is composed of the frictional member 3 fixedly secured to a core plate 2a.

A spring balance 5 is provided to measure a transmission torque.

A load cell 6 is adapted to measure a load for pressing the rotor 2 against the stator 1.

The spring balance 5 and the load cell 6 are provided for executing a test described later, and are not members for constituting the ultrasonic motor of the present invention.

The frictional member 3 which is employed in the present embodiment is a paper-type wet frictional member and has a porosity of 40 to 60%. The hardness of the frictional member 3 is 92 to 94, based on HRR (the standard load is 98.07 N, and a test load is 588.4 N).

The paper-type wet frictional member is comprised of a fiber base material, filler/friction adjusting agent, and binder. First, the fiber base material and the filler/friction adjusting agent are dispersed in water and a sheet-shaped product is formed by paper making from the slurry thereof. This product is dried to obtain a raw paper sheet. The binder is caused to permeate through the raw paper sheet and the raw paper sheet is then subjected to heating and curing, thereby obtaining a wet frictional member.

The fiber base material may comprise, for example, an organic synthetic fiber such as cellulose fiber, aramid fiber or carbon fiber, or an inorganic fiber such as glass fiber, lock wool, or potassium titanate fiber. The filler/friction adjusting agent may comprise diatomaceous earth, cashew resin, alumina, or the like, while the binder may comprise hydrolysis liquid of silane coupling agent, phenolic resin, silicone resin, or the like.

The raw paper sheet is comprised of, for example, 55 wt % of the fibrous base member and 45 wt % of filler/friction adjusting agent. A ratio of the binder is 40 parts by weight when this raw paper sheet is 100 parts by weight.

Further, the heating and curing described above is performed at 150° C. for 30 minutes.

Next, description will be made on bonding of the wet frictional member thus obtained to the rotor.

A thermosetting adhesive is applied onto one of the rotor 2 and the wet frictional member 3, and is temporarily dried and hardened. Then, the rotor 2 and the wet frictional member 3 are laid to overlap each other and are retained with a predetermined pressure for a predetermined period by a metal mold heated to a predetermined temperature.

The adhesive to be used here is, for example, a phenolic thermosetting adhesive, and the adhesion can be performed under the conditions that the heating temperature of the metal mold is 200° C., the retaining period is 30 s, and the pressure is 5 MPa.

Note that the present invention is not limited to the foregoing embodiment and can be varied in various manners.

### EXAMPLE

(Test Conditions)

In a testing device as shown in FIG. 1, the pressing force F against the rotor is 490 N both in an example of the present invention and a comparative example, the voltage is 200 Vpp both in the example and the comparative example, and the surface area of the wet frictional member is about 1545 mm² both in the example and the comparative example. (The outer diameter φ is 88, the inner diameter φ is 76)

A sample in the comparative example is PEIGF (made of synthetic resin). The porosity of the sample is zero, and the hardness is 125 based on HRM.

(Subjects to be Compared)

Both in the example and the comparative example, the ultrasonic motor is operated under the above testing conditions, so as to compare and examine (1) the maximum actuating torque and (2) the speed of rotation at that time.

(Results)

In the example, (1) the maximum actuating torque is 0.9 N·m, and (2) the speed of rotation is 20 to 25 rpm.

In the comparative example, (1) the maximum actuating torque is 0.5 N·m, and (2) the speed of rotation is 15 to 20 rpm.

As a result, according to the present invention (example), even when the voltage to be supplied to the ultrasonic motor and the pressing load are set as those in the comparative example (prior art), it is possible to maintain the coefficient of friction of the frictional member high to increase the frictional force between the stator 1 and the rotor 2, thereby increasing the torque capacity and the speed of rotation.

Note that the present invention is not limited to the example described above, but may be altered in various manners.

1. An ultrasonic motor with a frictional member interposed between a vibrator and a member to be vibrated, wherein said frictional member has a porosity of 20 to 80%.

2. An ultrasonic motor according to claim 1, wherein the hardness of said frictional member is 60 to 100 based on HRR.

3. An ultrasonic motor according to claim 1, wherein said frictional member is a paper type wet frictional member.

4. An ultrasonic motor according to claim 1, wherein said frictional member is fixedly secured to at least one of said vibrator and said member to be vibrated.

5. An ultrasonic motor according to claim 1, wherein said vibrator is a stator while said member to be vibrated is a rotor.

6. An ultrasonic motor according to claim 5, wherein said stator which is formed of a piezoelectric element and an elastic member fixedly secured thereto and said rotor with a wet frictional member secured thereto are disposed to overlap each other to be rotatable coaxially, and load imparting means for imparting a load for binding said stator and said rotor together is further provided.

7. An ultrasonic motor according to claim 5, wherein said stator which is formed of a piezoelectric element and a wet frictional member secured thereto and said rotor with an elastic member secured thereto are disposed to overlap each other to be rotatable coaxially, and load imparting means for imparting a load for binding said stator and said rotor together is further provided.

8. An ultrasonic motor according to claim 2, wherein said frictional member is a paper type wet frictional member.

9. An ultrasonic motor according to claim 2, wherein said frictional member is fixedly secured to at least one of said vibrator and said member to be vibrated.

10. An ultrasonic motor according to claim 2, wherein said vibrator is a stator while said member to be vibrated is a rotor.

11. An ultrasonic motor according to claim 10, wherein said stator which is formed of a piezoelectric element and an elastic member fixedly secured thereto and said rotor with a wet frictional member secured thereto are disposed to overlap each other to be rotatable coaxially, and load imparting means for imparting a load for binding said stator and said rotor together is further provided.

12. An ultrasonic motor according to claim 7, wherein said stator which is formed of a piezoelectric element and a wet frictional member secured thereto and said rotor with an elastic member secured thereto are disposed to overlap each other to be rotatable coaxially, and load imparting means for imparting a load for binding said stator and said rotor together is further provided.
